(19) United States
(12) Patent Application Publication
(10) Pub. No.: US 2023/0236074 A1
(43) Pub. Date: Jul. 27, 2023

(54) STRAIN SENSOR AND FABRICATION METHOD THEREOF

(71) Applicant: ELECTRONICS AND TELECOMMUNICATIONS RESEARCH INSTITUTE, Daejeon (KR)

(72) Inventors: Woo Seok YANG, Daejeon (KR); Kyung Soo CHO, Daejeon (KR); Sung Hoon HONG, Daejeon (KR)

(21) Appl. No.: 17/941,796

(22) Filed: Sep. 9, 2022

(30) Foreign Application Priority Data
Jan. 25, 2022 (KR) 10-2022-0010848
Jun. 23, 2022 (KR) 10-2022-0076707

(51) Int. Cl. G01L 1/18

(52) U.S. Cl. CPC G01L 1/18

(57) ABSTRACT

Disclosed herein to a strain sensor and a method for fabricating the strain sensor. According to an embodiment of the present disclosure, there is provided a strain sensor. The strain sensor comprising: a stretchable piezoresistor formed by a composite of a conducting nanocarbon filler distributed within a matrix of an insulating elastomer; and a stretchable electrode which is formed by a composite of a metal filler distributed within the matrix of the insulating elastomer and is partially inserted into both ends of the stretchable piezoresistor, wherein resistance increases due to a longitudinal tensile strain of the piezoresistor.

### CROSS REFERENCE TO RELATED APPLICATION

The present application claims priority Korean patent applications 10-2022-0010848, filed Jan. 25, 2022, and 10-2022-0076707, filed Jun. 23, 2022, the entire contents of which are incorporated herein for all purposes by this reference.

### BACKGROUND OF THE INVENTION

### Field of the Invention

The present disclosure relates to a strain sensor and a method for fabricating the strain sensor, and more particularly, to a strain sensor including a piezoresistor and a method for fabricating the strain sensor.

### Description of the Related Art

Strain sensors are applied to various fields such as safety monitoring of building structures, motion and health monitoring for human body, and growth monitoring for crops.

As one type of strain sensors, the piezoresistive-type strain sensor has a piezoresistor installed on its part subjected to an external force and may measure a strain by measuring a change of resistance according to a length change of the piezoresistor caused by an external force.

### SUMMARY

The present disclosure is technically directed to provide a strain sensor including a piezoresistor and a method for fabricating the strain sensor.

Other objects and advantages of the present invention will become apparent from the description below and will be clearly understood through embodiments. In addition, it will be easily understood that the objects and advantages of the present disclosure may be realized by means of the appended claims and a combination thereof.

Disclosed herein are a strain sensor and a method for fabricating the strain sensor. According to an embodiment of the present disclosure, there is provided a strain sensor. The strain sensor comprising: a stretchable piezoresistor formed by a composite of a conducting nanocarbon filler distributed within a matrix of an insulating elastomer; and a stretchable electrode which is formed by a composite of a metal filler distributed within the matrix of the insulating elastomer and is partially inserted into both ends of the stretchable piezoresistor, wherein resistance increases due to a longitudinal tensile strain of the piezoresistor.

According to the embodiment of the present disclosure, the strain sensor further comprising a stretchable coverlayer which is formed by the insulating elastomer and encloses surfaces of the stretchable piezoresistor.

According to the embodiment of the present disclosure, wherein the conducting nanocarbon filler comprises a mixture of a carbon nanotube and carbon black, and a weight ratio of the carbon nanotube is in a range of 10 to 40 wt%.

According to the embodiment of the present disclosure, wherein the insulating elastomer has an elastic modulus in a range of 50 to 350 kPa, when a strain is 100%.

According to the embodiment of the present disclosure, wherein the metal filler comprises a silver filler with a microsize or nanosize silver particle or a silver-coated copper core-shell particle, and wherein a weight ratio of the metal filler in the composite of the metal filler is in a range of 60 to 80 wt%.

According to the embodiment of the present disclosure, wherein a weight ratio of the conducting nanocarbon filler in the composite of the conducting nanocarbon filler is in a range of 6 to 12 wt%.

According to the embodiment of the present disclosure, wherein a length-to-width ratio of the stretchable piezoresistor is in a range of 5 to 15, and wherein a width-to-thickness ratio of the stretchable piezoresistor is in a range of 5 to 15.

According to the embodiment of the present disclosure, wherein a thickness of the stretchable electrode is in a range of 50 to 100% of a thickness of the stretchable piezoresistor.

According to the embodiment of the present disclosure, wherein a total thickness of the stretchable coverlayer is in a range of 200 to 350% of a thickness of the stretchable piezoresistor.

According to the embodiment of the present disclosure, wherein a resistance value is in a range of 5 to 50 kΩ when strain is zero, wherein a measurable strain is in a range of 0 to 300%, and wherein a gauge factor is in a range of 1 to 4.

According to another embodiment of the present disclosure, there is provided a method for fabricating a strain sensor. The method comprising: forming a first stretchable piezoresistor and a second stretchable piezoresistor on a first substrate and a second substrate by using a composite of a conducting nanocarbon filler distributed within a matrix of an insulating elastomer respectively; partially inserting a stretchable electrode, which is formed by a composite of a metal filler distributed within the matrix of the insulating elastomer, between the first stretchable piezoresistor and the second stretchable piezoresistor; bonding the partially inserted stretchable electrode with the first and second stretchable piezoresistors and the first stretchable piezoresistor and the second stretchable piezoresistor; and forming the strain sensor by separating the first substrate and the second substrate from the first stretchable piezoresistor and the second stretchable piezoresistor.

According to the another embodiment of the present disclosure, the method further comprising forming a first coverlayer film and a second coverlayer film on the first substrate and the second substrate by using an insulating elastomer solution respectively, wherein the forming of the first stretchable piezoresistor and the second stretchable piezoresistor forms the first stretchable piezoresistor and the second stretchable piezoresistor on the first coverlayer film and the second coverlayer film respectively.

According to the another embodiment of the present disclosure, wherein the bonding bonds the partially inserted stretchable electrode with the first and second stretchable piezoresistors and the first stretchable piezoresistor and the second stretchable piezoresistor through a thermal bonding process in which a predetermined pressure is applied to the first substrate and the second substrate heated to a predetermined temperature.

According to another embodiment of the present disclosure, there is provided a RFID strain sensor. The RFID strain sensor comprising: a supporter: a RFID chip, an antenna, a resistor chip and sensor interface pads on the supporter; and a strain sensor electrically connected with the sensor interface pads, wherein the strain sensor comprises: a stretchable piezoresistor formed by a composite of a conducting nanocarbon filler distributed within a matrix of an insulating elastomer; and a stretchable electrode which is formed by a composite of a metal filler distributed within the matrix of the insulating elastomer and is partially inserted into both ends of the stretchable piezoresistor, and wherein the RFID chip is configured to: measure a resistance value of the strain sensor based on a resistance value of the resistor chip, convert the resistance value of the strain sensor to a digital signal, and transmit the digital signal wirelessly through the antenna.

The features briefly summarized above with respect to the present disclosure are merely exemplary aspects of the detailed description below of the present disclosure, and do not limit the scope of the present disclosure.

According to the present disclosure, it is possible to provide a strain sensor including a piezoresistor and a method for fabricating the strain sensor.

According to an embodiment of the present disclosure, it is possible to provide a strain sensor capable of measuring a strain with high accuracy across a wide measurement range and a method for fabricating the strain sensor.

According to an embodiment of the present disclosure, it is possible to provide a RFID strain sensor that converts a measured strain to a digital signal and transmits the digital signal to the outside wirelessly.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1A and FIG. 1B are a plan view and a sectional view respectively for a strain sensor according to an embodiment of the present disclosure.

FIG. 2A and FIG. 2B are example views for describing microstructures of a piezoresistor and an electrode.

FIG. 3A to FIG. 3E are sectional views for describing a method of fabricating a strain sensor according to another embodiment of the present disclosure.

FIG. 4 is an example view for a fabricated strain sensor.

FIG. 5 is a graph showing a change of resistance according to a strain change of a strain sensor.

FIG. 6 shows a structure of a RFID strain sensor according to another embodiment of the present disclosure.

### DETAILED DESCRIPTION OF THE INVENTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

In the present document, such phrases as ‘A or B’, ‘at least one of A and B’, ‘at least one of A or B’, ‘A, B or C’, ‘at least one of A, B and C’ and ‘at least one of A, B or C’ may respectively include any one of items listed together in a corresponding phrase among those phrases or any possible combination thereof.

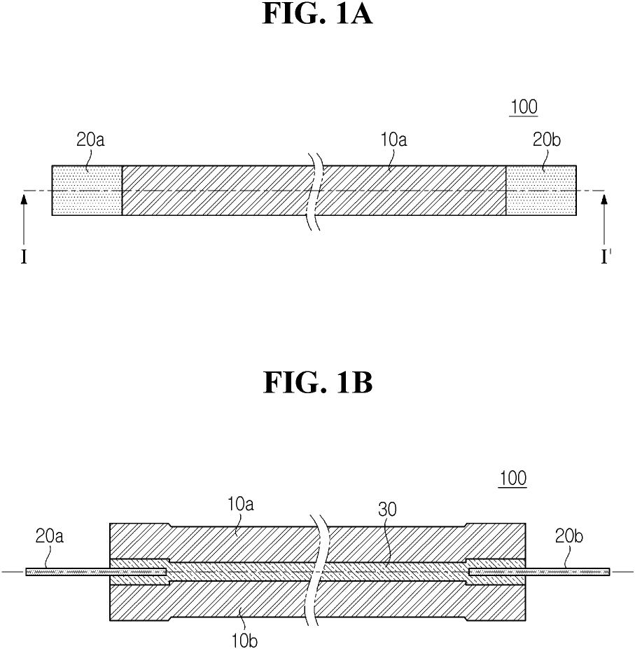

FIG. 1A and FIG. 1B are a plan view and a sectional view respectively for a strain sensor according to an embodiment of the present disclosure, and FIG. 1B shows a sectional view of I-I′ in FIG. 1A.

Referring to FIG. 1A and FIG. 1B, a strain sensor according to an embodiment of the present disclosure includes coverlayers 10a and 10b, electrodes 20a and 20b and a piezoresistor 30, which are stretchable.

The piezoresistor 30 is formed by a composite of conducting nanocarbon fillers distributed in a matrix of insulating elastomer.

Herein, the matrix means an insulating elastomer in which conducting nanocarbon fillers are distributed, and since the term “matrix” is self-evident to those who have skill in the art, no detailed description will be provided.

The piezoresistor 30 has a strip shape, of which the length/width ratio may be in the range of 5 to 15 and the width/thickness ratio may be in the range of 5 to 15. When the length/width ratio and width/thickness ratio of a piezoresistor are smaller than the respective ranges, the resistance of a sensor should increase along with an increase of strain, but the resistance may rather decrease, thereby causing the unstable sensor performance, and when those ratios are greater than the respective ranges, the mechanical durability of the sensor is degraded so that a measurable strain range can be reduced.

The electrodes 20a and 20b are formed by a composite of metal fillers distributed within a matrix of an insulating elastomer, and portions of the electrodes are inserted into both ends of a piezoresistor.

According to an embodiment, the electrodes 20a and 20b may include a silver filler with a microsize or nanosize silver particle or a silver-coated copper core-shell particle.

Herein, the electrodes 20a and 20b may have a strip shape of which the portions are inserted into both ends of the piezoresistor 30, and its thickness may be included in the range of 50 to 100% of that of the piezoresistor. When a ratio of the thickness of the electrodes 20a and 20b to the thickness of the piezoresistor 30 is smaller than the range, the mechanical durability of the electrodes is degraded so that the electrodes 20a and 20b can be broken while a sensor is being used, and when the ratio is greater than the range, the mechanical durability of the sensor is degraded at end portions of the piezoresistor where the electrodes 20a and 20b are inserted so that a measurable strain range can be reduced.

Coverlayers 10a and 10b are formed by an insulating elastomer to enclose the surfaces of the stretchable piezoresistor.

Herein, the coverlayers 10a and 10b have a strip shape which enclose the surfaces of the piezoresistor 30 or, more precisely, covers the upper and lower surfaces, and the thickness may be in the range of 200 to 350% of that of the piezoresistor 30. When a ratio of the thickness of the coverlayers 10a and 10b to the thickness of the piezoresistor 30 is smaller than the range, the mechanical durability of the coverlayers 10a and 10b is degraded so that the mechanical durability of the sensor can be degraded and thus repetitive service life can be reduced, and when the ratio is greater than the range, measurement is impossible if an external force causing a longitudinal tensile strain of the sensor is too small.

When the strain is zero, such a strain sensor may have a resistance value in a range of 5 to 50 kΩ, its measurable strain range may be in a range of 0 to 300%, and a gauge factor may be in a range of 1 to 4.

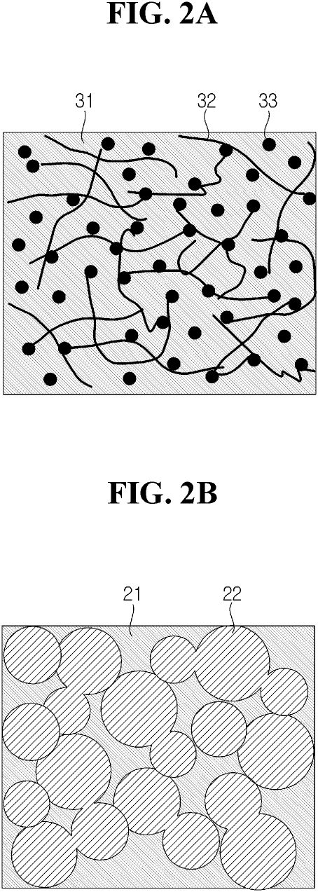

FIG. 2A and FIG. 2B are example views for describing microstructures of a piezoresistor and an electrode.

As illustrated in FIG. 2A, the stretchable piezoresistor 30 may be a composite of conducting nanocarbon fillers distributed in the matrix 31 of insulating elastomer.

Herein, the insulating elastomer may have a silicon-based rubber material which has an elastic modulus in a range of 50 to 350 kPa under 100% strain and whose mechanical failure is in a strain range of 600 to 1000%, and for example, the insulating elastomer 31 may include the commercial product Ecoflex or Dragon Skin. When the elastic modulus under 100% strain is below the range and a strain causing mechanical failure is above the range, the sensor may be soft like gel and be difficult to handle. In addition, when the elastic modulus is above the range and the strain is below the range, the corresponding disadvantage may be that a measurable strain range of the sensor is reduced.

A conducting nanocarbon filler may include a mixture of a carbon nanotube (CNT) 32 and carbon black (CB) 33, and a weight ratio of the carbon nanotube may be included in a range of 10 to 40 wt%. In case the weight ratio of the carbon nanotube is below the range, the resistance of a piezoresistor under zero strain may be above an adequate range, for example, a range of 5 to 50 kΩ, and in case the weight ratio is above the range, the disadvantage may be that the increase of resistance of the piezoresistor becomes less linear with the increase of strain.

In the stretchable piezoresistor 30 consisting of an insulating elastomer and a conducting nanocarbon filler, a weight ratio of the nanocarbon filler may be in a range of 6 to 12 wt%. In case the weight ratio of the nanocarbon filler is below the range, the resistance of the piezoresistor under zero strain may be above an adequate range, for example, a range of 5 to 50 kΩ, and another disadvantage may be that the increase of resistance of the piezoresistor becomes less linear with the increase of strain. On the other hand, in case the weight ratio of the nanocarbon filler is above the range, the disadvantage may be that the stretchable performance of the piezoresistor is degraded and thus a measurable strain range of a sensor is reduced.

As illustrated in FIG. 2B, the stretchable electrodes 20a and 20b may be a composite of metal filler 22 distributed in the matrix 21 of an insulating elastomer. According to an embodiment, the metal filler may include a silver filler with a microsize or nanosize silver particle or a silver-coated copper core-shell particle.

The insulating elastomer 21 may be identical with the insulating elastomer 31 constituting a piezoresistor. That is, the insulating elastomer 21 may have a silicon-based rubber material which has an elastic modulus in a range of 50 to 350 kPa under 100% strain and whose mechanical failure is in a strain range of 600 to 1000%, and for example, the insulating elastomer 31 may include the commercial product Ecoflex or Dragon Skin. The metal filler 22 may have a weight ratio in a range of 60 to 80 wt%. For example, in case the metal filler 22 has a weight ratio below the range, the electrodes 20a and 20b has a resistance above an adequate range of 100 Ω so that the resistance of a sensor may depend on the resistance of the electrodes 20a and 20b as well as that of the piezoresistor 30, and in case the metal filler 22 has a weight ratio above the range, the disadvantage may be that stretchable performance is degraded.

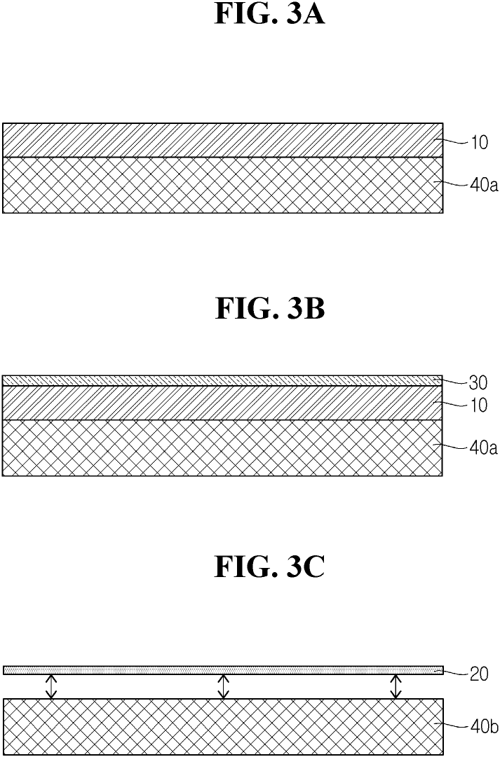

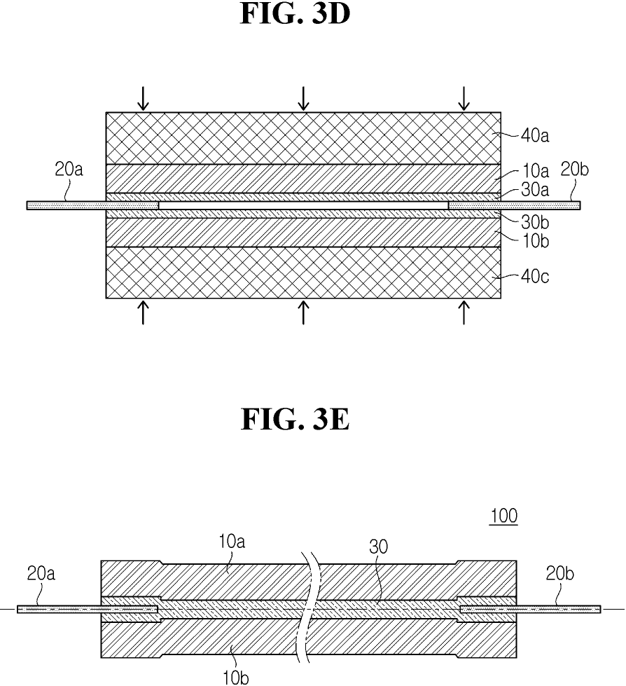

FIG. 3A to FIG. 3E are sectional views for describing a method of fabricating a strain sensor according to another embodiment of the present disclosure, that is, a process of fabricating the strain sensor of FIG. 1.

As illustrated in FIG. 3A, the method for fabricating a strain sensor according to another embodiment of the present disclosure forms a coverlayer film 10 on a substrate 40a by using an insulating elastomer solution. The substrate 40a may include PTFE (Polytetrafluoroethylene) as a polymer material with low surface energy and flexibility and be fixed to a dummy glass substrate. The coverlayer film 10 may be subject thermal curing in an oven after it is formed by a spin coating process.

Next, as illustrated in FIG. 3B, a piezoresistor film 30 is formed on the coverlayer film 10 by a bar coating process by using a composite paste of conducting nanocarbon fillers distributed within an insulating elastomer matrix. Of course, a process of forming the piezoresistor film 30 is not restricted or limited to the bar coating process, and every type of processes may be used which can form the piezoresistor film 30 on the coverlayer film 10.

Next, as illustrated in FIG. 3C, an electrode film is formed on another substrate 40b using a composite paste of a metal filler, for example, Ag filler distributed within an insulating elastomer matrix, and the stretchable electrode film 20 is completed by detaching the electrode film from the substrate. Herein, the substrate 40b may be identical with the one used in FIG. 3A, and the electrode film 20 may be formed by a bar coating process and then be subject to thermal curing in an oven.

Next, as illustrated in FIG. 3D, the two electrode films 20a and 20b removed through FIG. 3C are partially inserted between the two piezoresistor films 30a and 30b, and the piezoresistors 30a and 30b and the electrodes 20a and 20b are bonded together as well as the piezoresistor 30a and the piezoresistor 30b are bonded to each other. Herein, a thermal bonding process may be used by applying a pressure on a heated substrate.

As shown herein, a process of forming the coverlayer film 10 and the piezoresistor film 30 sequentially on a substrate may be implemented in two different substrates 40a and 40c respectively, and the two electrode films 20a and 20b may be partially inserted between the two piezoresistor films 30a and 30b by using two different substrates 40a and 40b, and the piezoresistors 30a and 30b and the electrodes 20a and 20b may be bonded together as well as the piezoresistor 30a and the piezoresistor 30b may be bonded to each other.

Next, as illustrated in FIG. 3E, when the substrates 40a and 40c are removed from a strain sensor body 100 in which the electrodes 20a and 20b, the piezoresistor 30 and the coverlayers 10a and 10b are integrated by a thermal compression process, a strain sensor of the present disclosure may be fabricated.

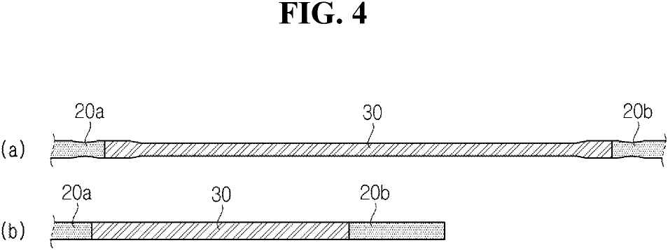

FIG. 4 is an example view for a fabricated strain sensor, FIG. 4A shows a strain sensor with an increased length under a longitudinal tensile strain of a piezoresistor, and FIG. 4B shows a strain sensor under zero strain.

In the fabricated strain sensor of FIG. 4, the piezoresistor 30 has a strip shape with a 65 mm length, a 5 mm width and a 0.12 mm thickness, and the electrodes 20a and 20b have a strip shape with a 5 mm width and a 0.1 mm thickness, which is inserted 5 mm at both ends of a piezoresistor. Herein, the piezoresistor 30 may be enclosed by a stretchable coverlayer, and FIG. 4 shows a case in which the coverlayer has a thickness of 0.25 mm.

As shown in FIG. 4, in a fabricated strain sensor, the piezoresistor 30 and the electrodes 20a and 20b are stretched by a longitudinal tensile strain.

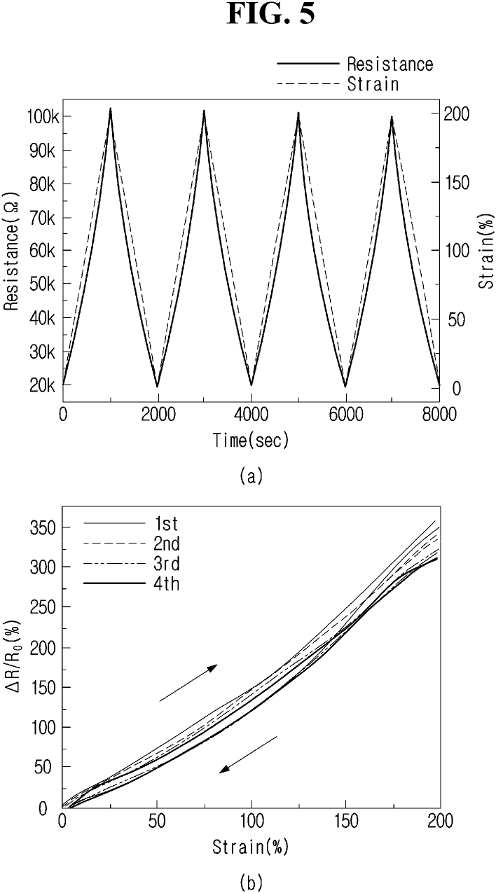

FIG. 5 is a graph showing a change of resistance according to a strain change of a strain sensor.

As shown in FIG. 5A, when strain is zero, the resistance (R₀) of a sensor is 20 kΩ, when the strain increases up to 200%, the resistance increases up to 100 kΩ, and when the strain decreases to 0%, the resistance decreases to 20 kΩ. According to a change of a tensile strain applied to a sensor in the measured strain range of 0 to 200%, the resistance of the sensor changes linearly.

In addition, as shown in FIG. 5B, a gauge factor, that is, a rate of a change in sensor resistance according to a change in strain (200%) is about 1.75, and a change of resistance repeats regularly and reproducibly according to a repetitive change of strain, thereby showing that the sensor has an excellent repetitive service life.

A strain sensor according to an embodiment of the present disclosure is connected to a RFID tag so that a RFID strain sensor may be embodied.

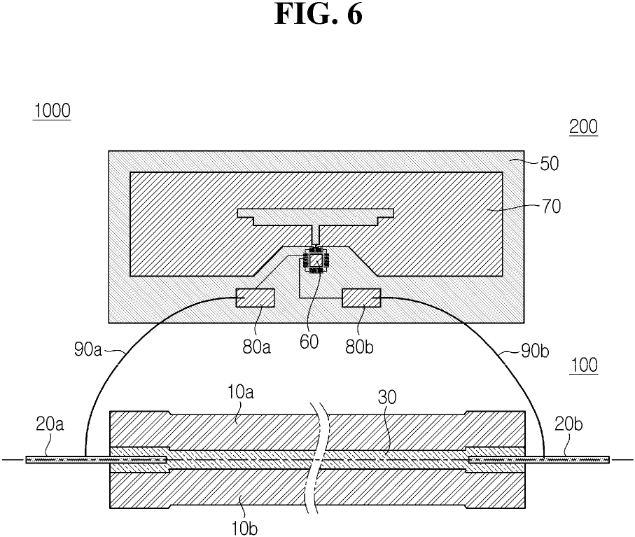

FIG. 6 shows a structure of a RFID strain sensor according to another embodiment of the present disclosure.

Referring to FIG. 6, a RFID strain sensor 1000 includes a strain sensor 100 and a RFID tag 200 electrically coupled with the strain sensor 100.

The strain sensor 100 includes the stretchable piezoresistor 30, the stretchable electrodes 20a and 20b and the stretchable coverlayers 10a and 10b, and the resistance increases under a longitudinal tensile strain of the piezoresistor 30. A strain sensor may include all the contents of FIG. 1 to FIG. 5 and include all the above-described stretchable features.

The RFID tag 200 includes a supporter 50, a RFID chip 60, an antenna 70, a resistor chip (not shown), and sensor interface pads 80a and 80b. The RFID chip 60, the antenna 70, the resistor chip, and sensor interface pads 80a and 80b may be formed on the supporter 50. The electrodes 20a and 20b of the strain sensor and the sensor interface pads 80a and 80b of the RFID tag 200 are electrically connected through electrical wires 90a and 90b. The RFID chip 60 may measure a resistance value of the strain sensor based on a resistance value of the resistor chip, convert the resistance value to a digital signal, and then wirelessly transmit the digital signal via the antenna 70.

In the RFID tag 200, the supporter 50 may include at least one of PET (Polyethylene terephthalate), polyester, and polyimide as a polymer material with flexibility. In addition, a resistance value of the resistor chip may be in a range of 5 to 50 kΩ when strain of the strain sensor 100 is zero. In addition, the RFID chip 60 and the antenna 70 may have a communication frequency in a range of 860 to 960 MHz. Of course, the communication frequency may be different according to a product with the RFID strain sensor and an application field.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

What is claimed is:

1. A strain sensor comprising:
a stretchable piezoresistor formed by a composite of a conducting nanocarbon filler distributed within a matrix of an insulating elastomer; and
a stretchable electrode which is formed by a composite of a metal filler distributed within the matrix of the insulating elastomer and is partially inserted into both ends of the stretchable piezoresistor,
wherein resistance increases due to a longitudinal tensile strain of the piezoresistor.

2. The strain sensor of claim 1, further comprising a stretchable coverlayer which is formed by the insulating elastomer and encloses surfaces of the stretchable piezoresistor.

3. The strain sensor of claim 1, wherein the conducting nanocarbon filler comprises a mixture of a carbon nanotube and carbon black, and a weight ratio of the carbon nanotube is in a range of 10 to 40 wt%.

4. The strain sensor of claim 4, wherein the insulating elastomer has an elastic modulus in a range of 50 to 350 kPa, when a strain is 100%.

5. The strain sensor of claim 1, wherein the metal filler comprises a silver filler with a microsize or nanosize silver particle or a silver-coated copper core-shell particle, and
wherein a weight ratio of the metal filler in the composite of the metal filler is in a range of 60 to 80 wt%.

6. The strain sensor of claim 1, wherein a weight ratio of the conducting nanocarbon filler in the composite of the conducting nanocarbon filler is in a range of 6 to 12 wt%.

7. The strain sensor of claim 1, wherein a length-to-width ratio of the stretchable piezoresistor is in a range of 5 to 15, and
wherein a width-to-thickness ratio of the stretchable piezoresistor is in a range of 5 to 15.

8. The strain sensor of claim 1, wherein a thickness of the stretchable electrode is in a range of 50 to 100% of a thickness of the stretchable piezoresistor.

9. The strain sensor of claim 2, wherein a total thickness of the stretchable coverlayer is in a range of 200 to 350% of a thickness of the stretchable piezoresistor.

10. The strain sensor of claim 1, wherein a resistance value is in a range of 5 to 50 kΩ when strain is zero,
wherein a measurable strain is in a range of 0 to 300%, and
wherein a gauge factor is in a range of 1 to 4.

11. A method for fabricating a strain sensor, the method comprising:
forming a first stretchable piezoresistor and a second stretchable piezoresistor on a first substrate and a second substrate by using a composite of a conducting nanocarbon filler distributed within a matrix of an insulating elastomer respectively;
partially inserting a stretchable electrode, which is formed by a composite of a metal filler distributed within the matrix of the insulating elastomer, between the first stretchable piezoresistor and the second stretchable piezoresistor;
bonding the partially inserted stretchable electrode with the first and second stretchable piezoresistors and the first stretchable piezoresistor and the second stretchable piezoresistor; and
forming the strain sensor by separating the first substrate and the second substrate from the first stretchable piezoresistor and the second stretchable piezoresistor.

12. The method of claim 11, further comprising forming a first coverlayer film and a second coverlayer film on the first substrate and the second substrate by using an insulating elastomer solution respectively,
wherein the forming of the first stretchable piezoresistor and the second stretchable piezoresistor forms the first stretchable piezoresistor and the second stretchable piezoresistor on the first coverlayer film and the second coverlayer film respectively.

13. The method of claim 11, wherein the bonding bonds the partially inserted stretchable electrode with the first and second stretchable piezoresistors and the first stretchable piezoresistor and the second stretchable piezoresistor through a thermal bonding process in which a predetermined pressure is applied to the first substrate and the second substrate heated to a predetermined temperature.

14. A RFID strain sensor, comprising:
a supporter:
a RFID chip, an antenna, a resistor chip and sensor interface pads on the supporter; and
a strain sensor electrically connected with the sensor interface pads,
wherein the strain sensor comprises: a stretchable piezoresistor formed by a composite of a conducting nanocarbon filler distributed within a matrix of an insulating elastomer; and
a stretchable electrode which is formed by a composite of a metal filler distributed within the matrix of the insulating elastomer and is partially inserted into both ends of the stretchable piezoresistor, and
wherein the RFID chip is configured to:
measure a resistance value of the strain sensor based on a resistance value of the resistor chip,
convert the resistance value of the strain sensor to a digital signal, and
transmit the digital signal wirelessly through the antenna.

15. The RFID strain sensor of claim 14, wherein the strain sensor further comprises a stretchable coverlayer which is formed by the insulating elastomer and encloses a surface of the stretchable piezoresistor.

16. The RFID strain sensor of claim 14, wherein the conducting nanocarbon filler comprises a mixture of a carbon nanotube and carbon black, and a weight ratio of the carbon nanotube is in a range of 10 to 40 wt%.

17. The RFID strain sensor of claim 14, wherein the supporter comprises at least one of PET (Polyethylene terephthalate), polyester, and polyimide as a polymer material with flexibility.
